(19) United States
(12) Patent Application Publication
(10) Pub. No.: US 2002/0170917 A1
(43) Pub. Date: Nov. 21, 2002

(54) Temperature cup

(76) Inventor: Anthony J. Gallo JR., St. Petersburg, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/156,551

(22) Filed: May 28, 2002

Related U.S. Application Data
(63) Continuation-in-part of application No. 09/678,685, filed on Oct. 3, 2000.
(60) Provisional application No. 60/157,564, filed on Oct. 4, 1999.

(51) Int. Cl. A47J 39/00; A47J 41/00

(52) U.S. Cl. 220/592.17

(57) ABSTRACT

A temperature moderating beverage container includes a cup and an insert, the cup having at least one wall. The insert seals against the cup wall and has a main chamber. An exterior wall of the insert together with the wall of the cup defines a temperature moderating chamber in fluid communication with the main chamber. A lid forms an airtight valve seal over the main chamber. The selective admission of air through the airtight valve seal urges a liquid within the main chamber into the temperature moderating chamber. The temperature moderating chamber and the main body are alternately formed within an insert having a vertical partition extending to the lip of the insert. A cap is designed to seat against the lip and with an intermediate gasket afford an airtight seal over the main chamber.

### RELATED APPLICATIONS

This application is a continuation-in-part of U.S. patent application Ser. No. 09/678,685 filed Oct. 3, 2000, now U.S. Pat. No. ______, and further claims the benefit of U.S. Provisional Application Serial No. 60/157,564 filed Oct. 4, 1999, which are hereby incorporated by reference.

### FIELD OF THE INVENTION

The present invention relates to beverage containers and, more particularly, to beverage containers suitable to moderate the temperature of a beverage portion prior to withdrawal from the container.

### BACKGROUND OF THE INVENTION

Beverages are often served at a temperature making immediate consumption unpleasant. Hot beverages such as coffee are maintained at or near the boiling temperature prior to service. A beverage consumed at a temperature of greater than 80° C. has the potential to scald or otherwise damage the mouth and lips of a consumer. Solutions to this problem have included stirring the beverage or waiting for thermal radiation to decrease the beverage temperature to a comfortable level to allow consumption. Additionally, ice or a cooler consumable liquid such as water or milk is added to decrease the beverage temperature. Unfortunately, upon cooling a beverage to a comfortable consumption temperature, the beverage temperature quickly decreases until a hot beverage is below the optimal consumption temperature.

A similar situation exists with cold beverages which have the potential to irritate sensitive dental structures or chill portions of the digestive tract to cause temporary cramps or pain.

With beverage consumption often occurring in transit, opportunities to moderate beverage temperature before consumption are limited. Thus, there exists a need for a beverage container capable of moderating the temperature of a beverage portion within a container while maintaining the majority of the beverage in an extreme temperature state.

### SUMMARY OF THE INVENTION

A temperature moderating beverage container includes a cup and an insert, the cup having at least one wall. The insert seals against the cup wall and has a main chamber. An exterior wall of the insert together with the wall of the cup defines a temperature moderating chamber in fluid communication with the main chamber. A lid forms an airtight valve seal over the main chamber. The selective admission of air through the airtight valve seal urges a liquid within the main chamber into the temperature moderating chamber. The temperature moderating chamber and the main body are alternately formed within an insert having a vertical partition extending to the lip of the insert. A cap is designed to seat against the lip and with an intermediate gasket afford an airtight seal over the main chamber.

### BRIEF DESCRIPTION OF THE DRAWINGS

The features and advantages of this invention will be apparent from the following detailed description of a preferred embodiment of an apparatus constructed in accordance with the invention, appended claims and the accompanying drawings wherein like reference numerals refer to like elements and wherein:

FIG. 1 is a partial cutaway perspective view of an embodiment of the present invention;

FIG. 2 is a partial cutaway side view of another embodiment of the present invention;

FIG. 3 is a partial cutaway side view of another embodiment of the present invention;

FIG. 4 is a partial cutaway side view of another embodiment of the present invention;

FIG. 5 is a partial cutaway side view of another embodiment of the present invention;

FIG. 6 is a partial cutaway side view of another embodiment of the present invention;

FIG. 7a is an exploded view of still another embodiment of the present invention;

FIG. 7b is a cutaway view of the embodiment depicted in FIG. 7a;

FIGS. 8a-c are side, exploded and perspective views of a lid constructed in accordance with the present invention;

FIG. 9a is an exploded view of an airtight sealable embodiment of the present invention;

FIG. 9b is a transverse cutaway view of the embodiment depicted in FIG. 9a in the plane A-A;

FIG. 9c is a transverse cutaway view of the embodiment depicted in FIG. 9a in the plane B-B;

FIG. 10a is an exploded view of a liner containing embodiment of the present invention; and

FIG. 10b is a transverse cutaway view of the embodiment depicted in FIG. 10a in the plane A-A.

### DETAILED DESCRIPTION OF THE INVENTION

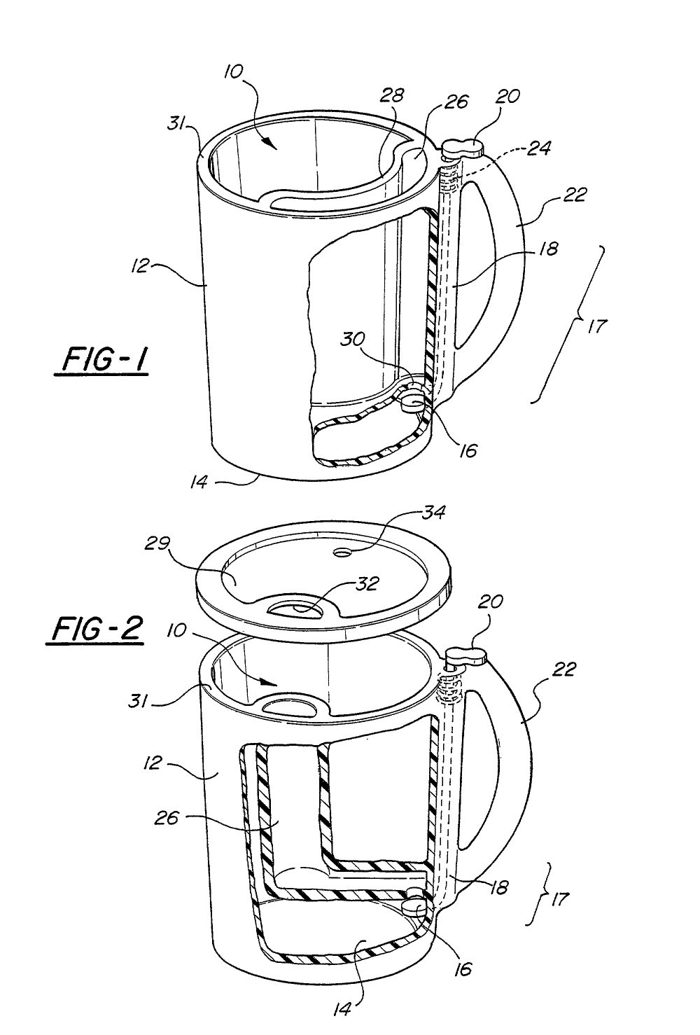

Referring now to FIGS. 1-5, and as best shown in FIG. 1, a main chamber 10 contains the largest proportion of a beverage within a container construction in accordance with the present invention. The container is defined by an outer cylindrical wall 12 and a circular base 14. A valve assembly 17 includes a valve 16 having a stem 18 extending beyond the exterior of the cylindrical wall 12 and terminating in a button 20 adapted to be engaged by a human hand grasping the container. The button 20 is situated proximal to a handle 22 extending from the wall 12.

The valve 16 selectively engages, through pressure displacement of the button 20, an aperture 30 formed in a temperature-moderating chamber 26. Preferably, the valve stem 18 engages a coil spring 24 that biases the valve in a closed relationship over the aperture 30. The application of pressure to the button 20 displaces the valve 16. Therefore, the valve 16, upon displacement, controls fluid communication between the main chamber 10 and the temperature-moderating chamber 26.

Preferably, the moderating chamber is integral with the cylindrical outer wall 12 and is defined by a partitioning wall segment 28, as shown in FIG. 1. Alternatively, as discussed below, the chamber 26 may be removably inserted and mounted within the main chamber 10 and, conversely, the main chamber 10 may be removably inserted within the chamber 26.

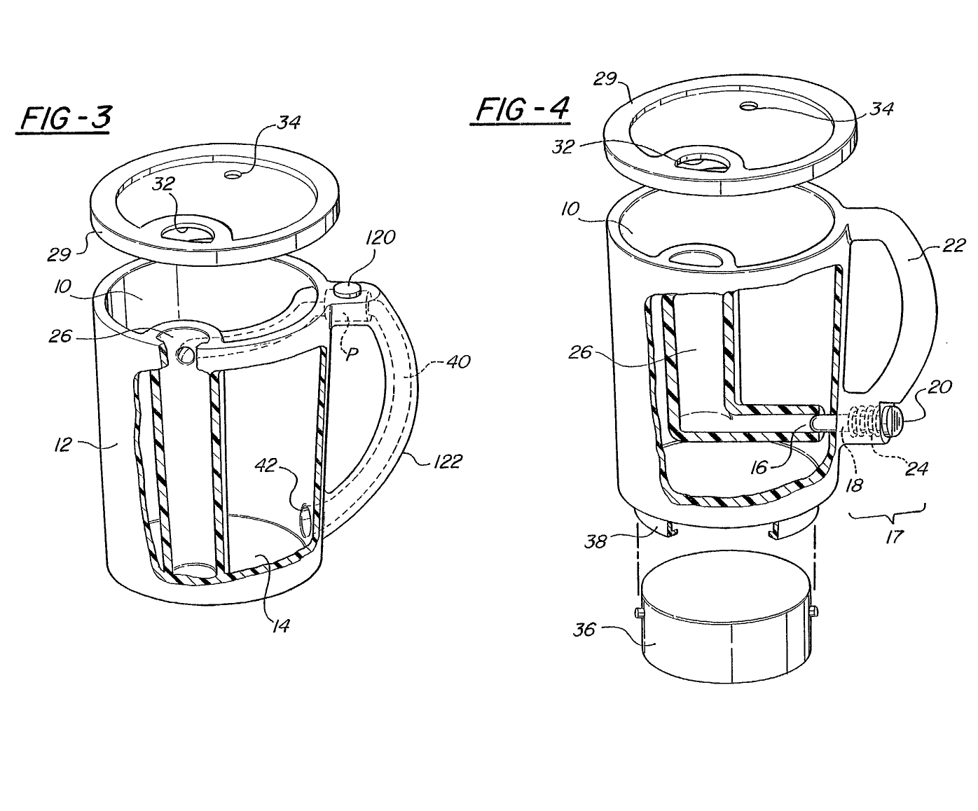

It is appreciated that the shape and dimensions of the temperature-moderating chamber 26 may be modified relative to the position of the handle 22 in order to facilitate ease of consumption and container cleaning. For example, alternatively, the temperature-moderating chamber 26, as shown in the embodiments depicted in FIGS. 2-4, is formed as a generally tubular member. Furthermore, it is preferred that the chamber 26 is of a smaller volume than the main chamber 10. However, it is appreciated that the chamber 26 may also be of equal or greater volume than the main chamber 10.

Optionally, as shown in FIGS. 2-4, a container of the present invention is fitted with a complementary lid 29 adapted to cover the cylindrical wall edge 31. The lid 29 having therein a sipping hole 32 from which beverage is withdrawn from the container and an air hole 34 designed to equilibrate pressures between the interior and exterior of the container.

Preferably, the temperature-moderating chamber 26 is defined by a wall material having insulating properties to diminish thermal conductivity between beverage within the main chamber 10 and the temperature-moderating chamber 26. A temperature-moderating chamber of the present invention is thermally isolated from the main chamber of a container by structures illustratively including a double walled insulated segment, foamed polymeric core materials, and low thermal conductivity polymeric materials. More preferably, the container is molded from a thermoplastic material as a unitary piece with the lid 29, the valve assembly 17, and the spring 20 being separate components.

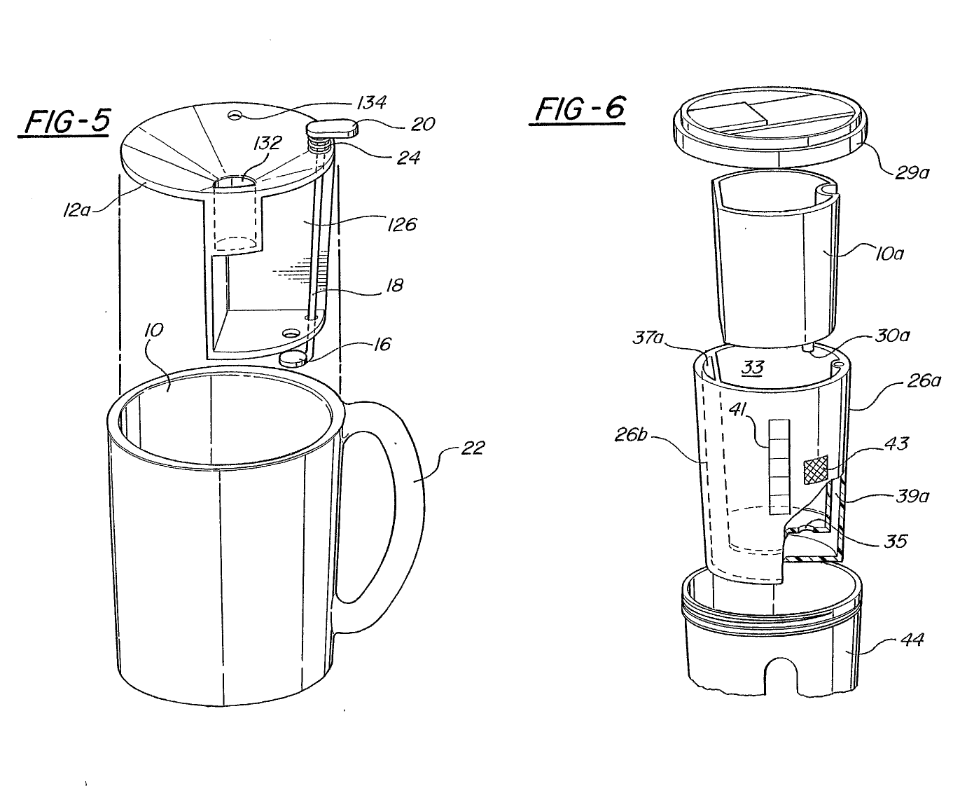

In an alternative embodiment shown in FIG. 3, the chamber 26 is in fluid communication with the main chamber 10 by way of a side tube 40. The side tube 40 has an opening 42 proximal to the circular base 14 and extends beyond the cylindrical wall 12 to form a handle 122, the side tube 40 top portion terminating within the temperature-moderating chamber 26. The side tube 40 being equipped with a button 120. Upon compression, the button 120 activates a pumping mechanism “P” to draw a beverage from the main chamber 10 into the chamber 26.

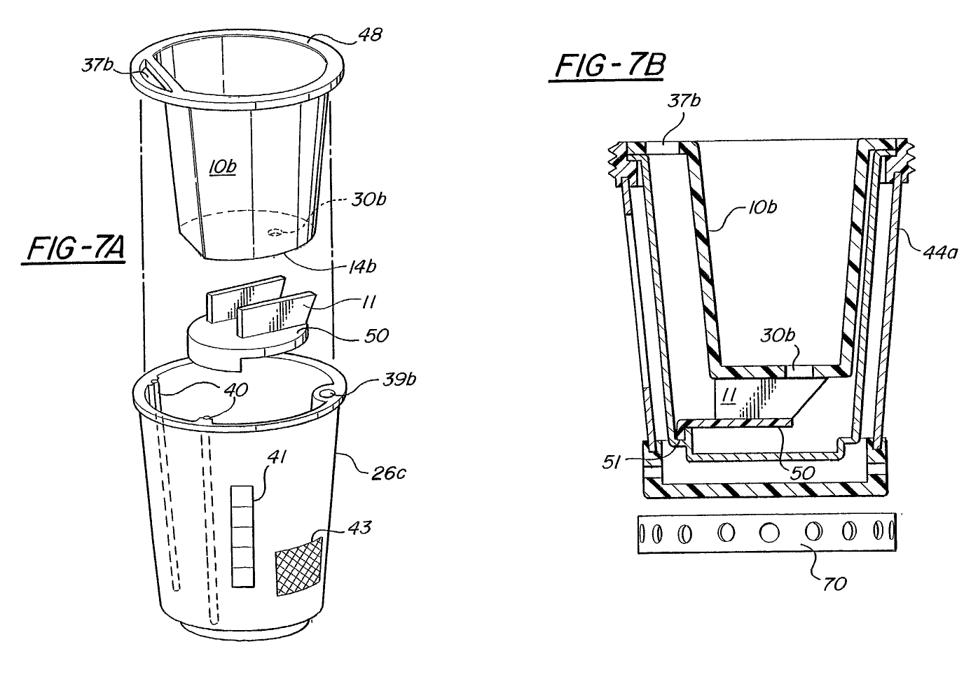

Referring now to FIG. 4, in an alternative embodiment a selectively engageable holder 36 engages a mounting fixture 38 extending below the circular base 14. Preferably, the base 36 is adapted to fit within a standard vehicle cup holder.

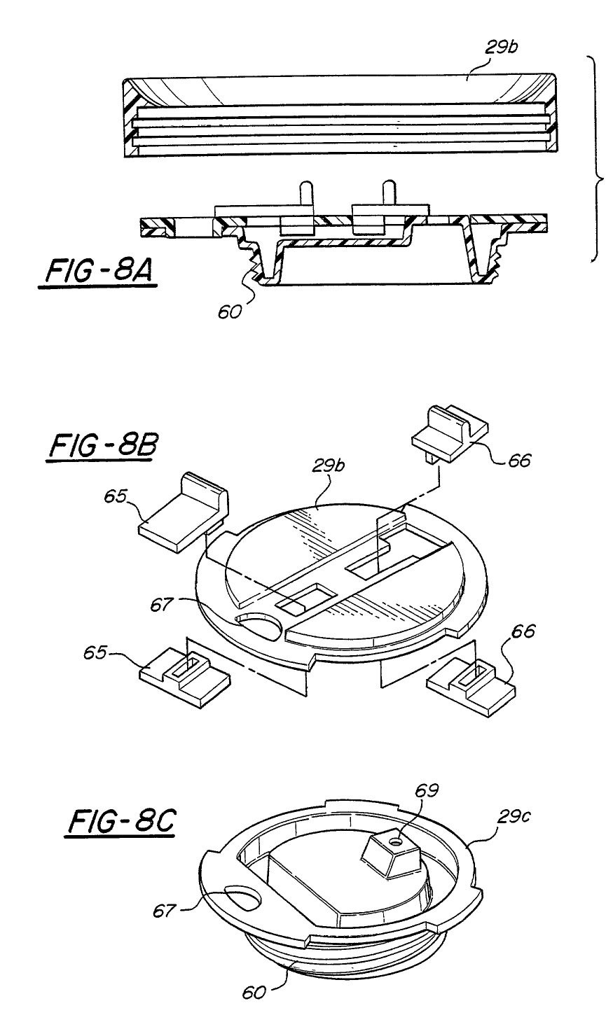

Referring now to FIG. 5, the temperature-moderating chamber 126 is optionally integrated into a lid 129 having a sipping hole 132 therein and at least one air hole 134. Preferably, both the temperature moderating chamber 126 and the main chamber 10 are in gaseous communication with air hole 134 to facilitate steady fluid consumption by way of the sipping hole 132.

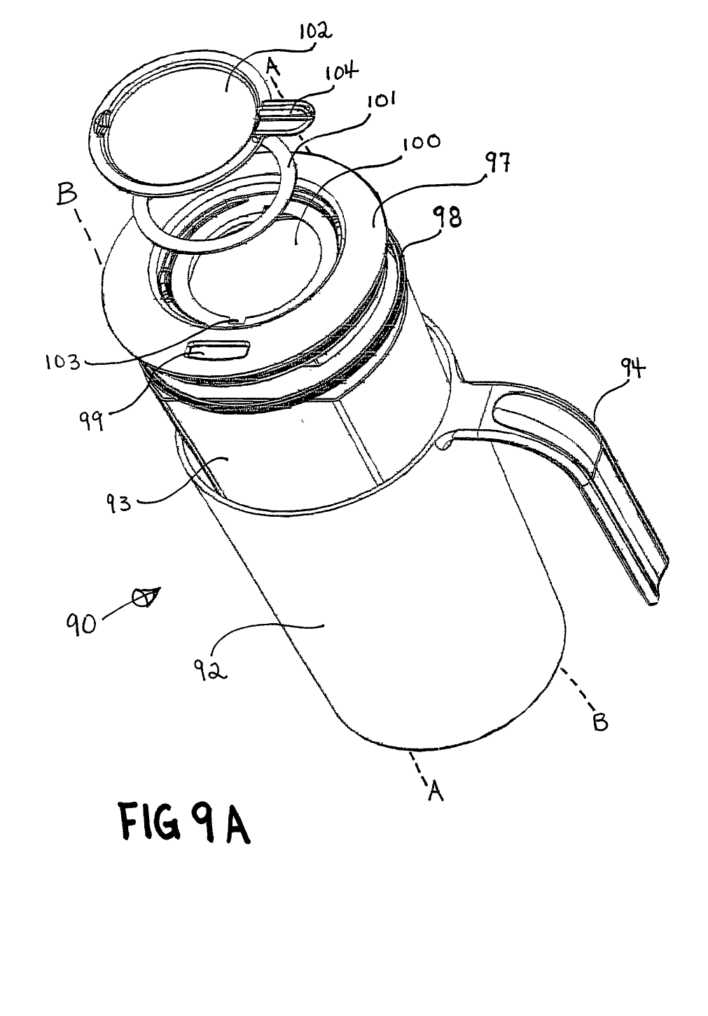

Referring now to FIG. 6, there is shown a further alternative embodiment of the present invention. In this embodiment, the main chamber 10a is preferably a generally cylindrical container having an aperture 30a. The main chamber 10a is removably disposed within a nesting chamber 33 formed in the temperature-moderating body 26a. Preferably, the nesting chamber 33 includes an aperture 35 that aligns with the aperture 30a (when the main chamber 10a is positioned within the nesting chamber 33) to fluidly communicate beverage into the temperature-moderating chamber 26b. It is appreciated that the shapes of the nesting chamber 33 and the main chamber 10a may be modified (e.g., tapered, alignment grooves) to facilitate proper alignment of the apertures 30a and 35. The chamber 26b preferably includes a sipping portion 37a for use by the consumer and a vent 39a to assist in equalizing pressures within the container.

Still referring to FIG. 6, a thermometer 41 is disposed on the exterior of the chamber 26b to provide the consumer with information concerning the temperature of the beverage within the container. Preferably, the thermometer is a strip type digital thermometer. However, most any variety of thermometer could be adapted for this function. Additionally, a logo 43 or other indicia may be printed on the body 26a to convey an advertising or promotional message.

The main chamber 10a and temperature moderating body 26a (with chamber 26b) are preferably further removably disposed within an insulating cup 44 to provide an additional thermal barrier between the consumer and the hot beverage. Preferably, the cup 44 includes a window portion that is alignable with the thermometer 41 and/or indicia. However, it is appreciated that the cup 44 may also include indicia for advertising or promotions. Preferably, a lid 29a having a sipping aperture and a vent threadably engages the top portion of the cup 44 to seal the beverage inside the container.

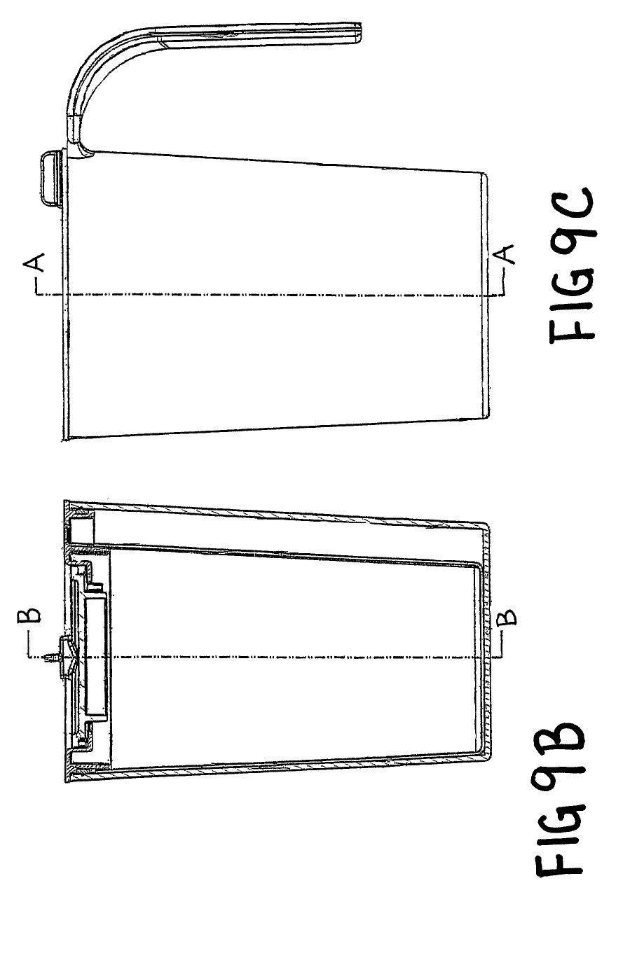

Referring now to FIGS. 7a and 7b, there is shown a still further alternative embodiment of a container constructed in accordance with the present invention. A main chamber 10b is removably secured within a temperature moderating chamber 26c. An aperture 30b is defined in the main chamber 10b to allow fluid communication between the main chamber 10b and the moderating chamber 26c. Preferably, the main chamber includes a lip portion 48 having a sipping aperture 37b. As seen in FIG. 7, the lip portion 48 serves to enclose the moderating chamber 26c.

Still referring to FIGS. 7a and 7b, the base 14b of the main chamber 10b includes a support 11 extending downwardly from said base 14b and terminating at a flange member 50. The flange member 50 preferably cooperates with a groove portion 51 disposed on the interior of the moderating chamber 26c to assist with the support of the main chamber 10b within the moderating chamber 26c. A vent 39b is preferably defined within the chamber 26c to assist in cooling and pressure equalization. A pair of ribs 40 are preferably disposed on the interior of the chamber 26c that sealingly engage the exterior of the main chamber 10b to define a sipping passage aligned with the sipping aperture portion 37b. Furthermore, as discussed above, a thermometer 41 or logo 43 may be provided on the exterior of the chamber 26c.

The moderating chamber 26c with the main chamber 10b are preferably removably secured within a cup 44a. Preferably, the cup 44a includes a window to view the thermometer 41 and/or logo 43. A vent cap 70 is preferably provided on the base of the cup to assist in cooling the beverage within the container.

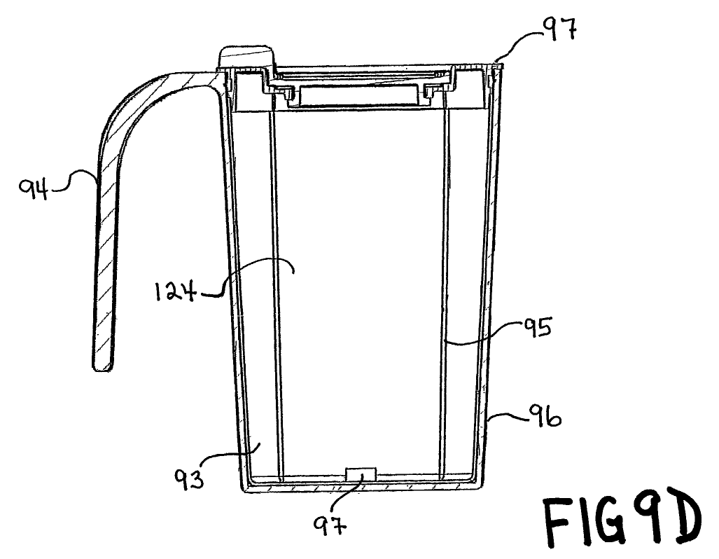

Referring now to FIGS. 8a-c, a lid 29b having o-rings 60 or similar sealing means is preferably threadably affixed to said cup 44 or 44a. to seal the container. Alternatively, as seen in FIG. 8c, the lid 29c may be removably snap-fit onto the cup 44 or 44a. A sipping aperture 67 communicates with sipping portion 37a or 37b to permit the consumer to consume their beverage. Additionally, a cooling vent 69 is provided to assist in cooling the main chamber 10a and pressure equalization. Alternatively, a plurality of apertures 61 and 63 having slide valve assemblies 65 and 66 may be defined within the lid 29b to provide communication with the sipping portion 37a or 37b and the main chamber 10a or 10b.

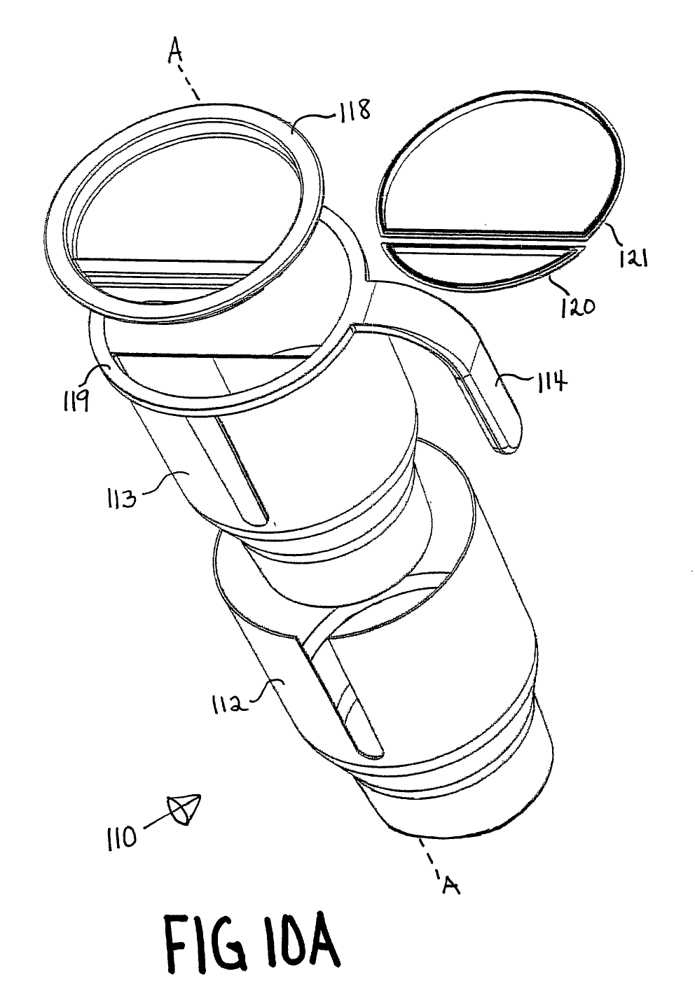

Referring now to FIGS. 9a-c, an airtight sealable cup embodiment of the present invention is shown generally at 90. A shell 92 is adapted to receive therein an insert 93. Optionally, the shell 92 integrates a handle 94. The shell 92 is typically constructed of an injection molded thermoplastic material or metal, metal preferably being stainless steel. The insert 93 has a main body 94 defined by a sidewall 95. The sidewall 95 and the interior of shell 92 together defining a temperature moderating chamber 96. It is appreciated that the volume of the temperature moderating chamber 96 is modified either at the expense of the main body 94 or through the enlargement of the interior volume of the shell 92. An aperture 97 affords fluid communication between the main body 94 and the temperature moderating chamber 96. While the aperture 97 is depicted in the figures at the base of the main body 94, it is appreciated that an aperture located in the basal region of sidewall 95 is also operative herein to afford communication between the main body 94 and the temperature moderating chamber 96. A lid 97 is encompassed by a seal 98 such that the simultaneous engagement of the lid 97, the seal 98, the insert 93 and the shell 92 forms an airtight barrier between the insert 93 and the lid 97. The lid 97 has a sipping hole 99 therein, the sipping hole 99 in fluid communication with the temperature moderating chamber 96. The lid 97 also has a sealable flange 100, the flange 100 in fluid communication with the main body 94. The sealable flange 100 is adapted to receive a complementary diaphragm 101. The diaphragm 101 adapted to be intermediate between the sealable flange 100 and a lockable cap 102. The cap 102 and lid 97 together with the diaphragm 101 forming an airtight valve seal. In a preferred embodiment, the cap 102 has a key fitting (not shown) adapted to engage a complementary notch 103 in the edge of sealable flange 100. In operation, the cup 90 has a beverage poured through the sealable flange 100 and into the main body 94. The beverage level equilibrates to the same level within the temperature moderating chamber 96 as in the main body 94. Upon forming an airtight valve seal by engaging the cap 102 against the diaphragm 101 against the sealable flange 100, the air pressure within main body 94 retains beverage within the main body 94 even as liquid is withdrawn from the temperature moderating chamber 96 by way of sipping hole 99. Periodic rotation of cap 102 by exerting rotational pressure on cap lever 104, results in additional air entering the main body head space thereby urging beverage from the main body 94 into the temperature moderating S chamber 96 for consumption.

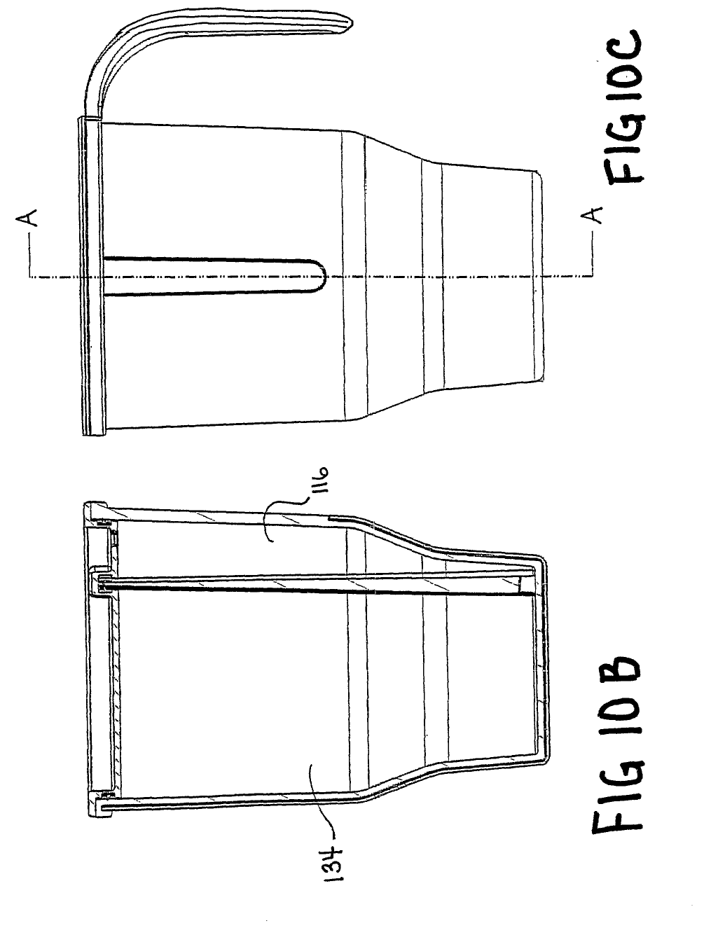

With reference to FIGS. 10a and 10b, a cup is shown generally at 110. The cup 110 has a shell 112 typically formed of an injectable thermoplastic material or stamped metal, the stamped metal preferably being stainless steel. An insert 113 fits into the volume of the shell 112, the insert 113 optionally having a handle 114 integral therewith. The insert 113 having a main chamber 114 and a temperature moderating chamber 116 formed therein, the main body 114 and the temperature moderating chamber 116 in fluid communication near the base of the insert 113. A cap 118 is adapted to engage a lip 119 of the insert 113 and to form selective airtight seals over the main body 114 and the temperature moderating chamber 116. Intermediate between the cap 118 and the lip 119 and the insert 113 are gaskets 120 and 121 intended to seal the temperature moderating chamber 116 and main body 114, respectively. The cup 110 operates through the movement of beverage content from the main chamber 114 to the temperature moderating chamber 116 based upon the relative air pressure exerted on the fluid.

While the present invention has been described in the context of a drinking vessel, it is appreciated that the present invention is readily fashioned into a serving pitcher. Embodiments of the present invention wherein the container serves as a pitcher have a sipping hole or temperature moderating chamber lip formed into a pouring spout.

The foregoing description is illustrative of particular embodiments of the invention, but is not meant to be a limitation upon the practice thereof. The following claims, including all equivalents thereof, are intended to define the scope of the invention.

I claim:

1. A temperature-moderating beverage container comprising in combination:
a cup and insert in combination, said cup having at least one wall;
an insert sealed against the wall of said cup, said insert having a main chamber and defining with the wall of said cup a temperature moderating chamber, the main chamber and the temperature moderating chamber being in fluid communication; and
a lid forming an airtight valve seal over the main chamber and having a sipping hole through which the temperature moderating chamber is accessible.

2. The beverage container of claim 1 further comprising a cap securing against said lid selectively forming the airtight valve seal.

3. The beverage container of claim 2 wherein said cap further comprises a cap lever.

4. The beverage container of claim 1 wherein said insert is formed of an injection molded thermoplastic material.

5. A temperature moderating beverage container comprising:
a shell;
an insert adapted to be received within said shell, the insert having an internal vertical partition coterminous with an insert lip, the partition defining a main chamber having a main chamber volume and a temperature moderating chamber having a temperature moderating volume, the main body volume being greater than the temperature moderating chamber volume, the main body in fluid communication with the temperature moderating chamber; and
a cap adapted to form an airtight valve seal against the insert lip and over the main chamber.

6. The beverage container of claim 5 wherein a gasket seats intermediate between the lip and said cap forming the airtight valve seal over the main chamber.

7. The beverage container of claim 5 further comprising a temperature moderating chamber gasket intermediate between the lip and said cap in contact with the partition so as to form a seal over the temperature moderating chamber.

8. The beverage container of claim 5 wherein said insert further comprises an integral handle.
